(19) United States
(12) Patent Application Publication
(10) Pub. No.: US 2014/0222513 A1
(43) Pub. Date: Aug. 7, 2014

(54) SYSTEM AND METHOD OF PROVIDING POLLING IN A TELEPHONE BASED PLATFORM

(71) Applicant: Alpine Audio Now, LLC, Reston, VA (US)

(72) Inventors: Marcel BARBULESCU, Falls Church, VA (US); Elan Joel BLUTINGER, Washington, DC (US); Jeffrey N. POLLACK, Los Angeles, CA (US)

(73) Assignee: Alpine Audio Now, LLC, Reston, VA (US)

(21) Appl. No.: 14/168,708

(22) Filed: Jan. 30, 2014

Related U.S. Application Data
(60) Provisional application No. 61/759,722, filed on Feb. 1, 2013.

(51) Int. Cl. G06Q 30/02

(52) U.S. Cl. CPC G06Q 30/0203
USPC 705/7.32

(57) ABSTRACT

Disclosed is a method for providing polls or surveys to users in the midst of a communication between a device and a server. The method includes establishing a communication between a device associated with a user and a server, receiving data about the user, based on the data, presenting a survey to the user during the communication between the device and the server to yield survey data and processing the survey data. Survey can be chosen based on the program the user is listening to as well as personal user data such that targeted personalized surveys can be offered that are likely to be taken by the user during the communication.

### PRIORITY CLAIM

This application claims priority to U.S. Provisional Patent Application No. 61/759,722 filed on 1 Feb. 2013, which is herein incorporated by reference in its entirety.

### Related Application

This application is related to U.S. patent application Ser. No. ______ filed on ______ (Attorney Docket 081-0113). The content of the application is incorporated herein by reference in its entirety.

### BACKGROUND OF THE INVENTION

1. Field of the Invention

The present disclosure is on polling and surveys that are provided to listeners of an audio program such as a radio station in which characteristics of the user can be identified to improve the polling experience.

2. Introduction

Presently, accurate polling data is difficult and expensive to achieve. Typically, pollsters need to go to door-to-door or make phone calls to individuals to provide the polling information. There are many expenses associated with outbound and door-to-door polls in which large numbers of people must be canvassed in order to obtain enough surveys from the prospects to be able to generate accurate results.

### SUMMARY

Additional features and advantages of the invention will be set forth in the description which follows, and in part will be obvious from the description, or may be learned by practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth herein.

The present disclosure focuses on novel polling mechanisms which allow a platform in which a user has made a phone call or other type of data communication or to listen to a streaming audio program such as a streaming radio station. The system enables a survey to a poll to be presented to the user in such a way that the survey is matched to the user and their interests. In such a mechanism, information about the user is obtained and used in order to determine which survey to present and/or process the survey. This improves the accuracy of polling to identify the character and interest of the subjects using such information as the radio station which they chose to listen to and other information about the listeners in order to choose or/and process the polls.

Further, in addition to or separate from a polling feature, the present disclosure enables a system to measure for a radio station or a broadcaster, the number of listeners in a particular increment of time, such as every 15 minutes, or every 5 minutes. This time period can be a rolling window or static such as increments from Noon to 12:15 PM. This system measures the actual number of listeners on a particular system, which can then be processed by an algorithm to provide an up-to-date, dynamic and ‘live’ view for broadcasters of their listening audience.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only exemplary embodiments of the invention and are not therefore to be considered to be limiting of its scope, the invention will be described and explained with additional specificity and detail through the use of the accompanying drawings in which:

FIG. 1 illustrates an example system embodiment;

FIG. 2 illustrates a system embodiment;

FIG. 3 illustrates a method embodiment of this disclosure; and

FIG. 4 illustrates another method embodiment.

### DETAILED DESCRIPTION

Various embodiments of the invention are discussed in detail below. While specific implementations are discussed, it should be understood that this is done for illustration purposes only. A person skilled in the relevant art will recognize that other components and configurations may be used without parting from the spirit and scope of the invention. The concepts disclosed herein focus on the abilities of performing focused polling of individuals engaged in a communication such as a phone call or a person receiving an audio or media program on a device. First, the basic system components will be discussed, followed by more details regarding the functionality performed by the system to enable more effective surveys.

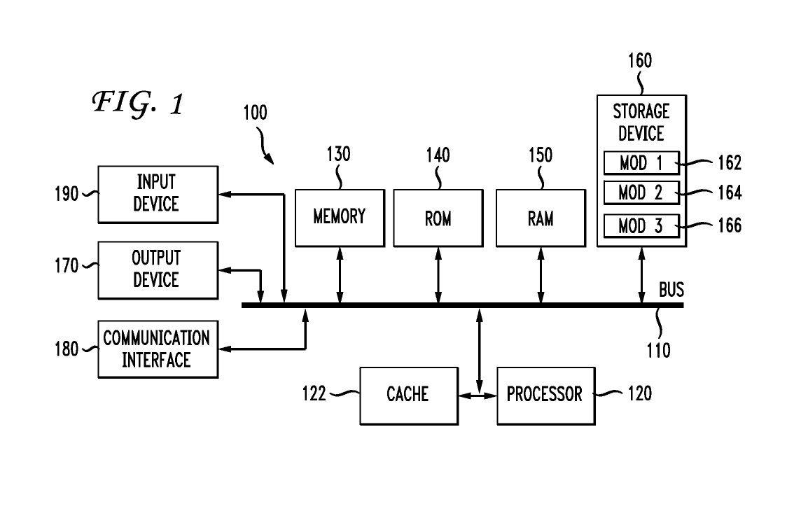

With reference to FIG. 1, an exemplary system includes a general-purpose computing device 100, including a processing unit (CPU) 120 and a system bus 110 that couples various system components including the system memory such as read only memory (ROM) 140 and random access memory (RAM) 150 to the processing unit 120. Other system memory 130 may be available for use as well. It can be appreciated that the invention may operate on a computing device with more than one CPU 120 or on a group or cluster of computing devices networked together to provide greater processing capability. The system bus 110 may be any of several types of bus structures including a memory bus or memory controller, a peripheral bus, and a local bus using any of a variety of bus architectures. A basic input/output (BIOS) stored in ROM 140 or the like, may provide the basic routine that helps to transfer information between elements within the computing device 100, such as during start-up. The computing device 100 further includes storage devices such as a hard disk drive 160, a magnetic disk drive, an optical disk drive, tape drive or the like. The storage device 160 is connected to the system bus 110 by a drive interface. The drives and the associated computer readable media provide nonvolatile storage of computer readable instructions, data structures, program modules and other data for the computing device 100. The basic components are known to those of skill in the art and appropriate variations are contemplated depending on the type of device, such as whether the device is a small, handheld computing device, a desktop computer, or a computer server.

Although the exemplary environment described herein employs the hard disk, it should be appreciated by those skilled in the art that other types of computer readable media which can store data that are accessible by a computer, such as magnetic cassettes, flash memory cards, digital versatile disks, cartridges, random access memories (RAMs), read only memory (ROM), a cable or wireless signal containing a bit stream and the like, may also be used in the exemplary operating environment.

To enable user interaction with the computing device 100, an input device 190 represents any number of input mechanisms, such as a microphone for speech, a touch-sensitive screen for gesture or graphical input, keyboard, mouse, motion input, speech and so forth. The input may be used by the presenter to indicate the beginning of a speech search query. The device output 170 can also be one or more of a number of output mechanisms known to those of skill in the art. In some instances, multimodal systems enable a user to provide multiple types of input to communicate with the computing device 100. The communications interface 180 generally governs and manages the user input and system output. There is no restriction on the invention operating on any particular hardware arrangement and therefore the basic features here may easily be substituted for improved hardware or firmware arrangements as they are developed.

For clarity of explanation, the illustrative system embodiment is presented as comprising individual functional blocks (including functional blocks labeled as a “processor”). The functions these blocks represent may be provided through the use of either shared or dedicated hardware, including, but not limited to, hardware capable of executing software. For example the functions of one or more processors presented in FIG. 1 may be provided by a single shared processor or multiple processors. (Use of the term “processor” should not be construed to refer exclusively to hardware capable of executing software.) Illustrative embodiments may comprise microprocessor and/or digital signal processor (DSP) hardware, read-only memory (ROM) for storing software performing the operations discussed below, and random access memory (RAM) for storing results. Very large scale integration (VLSI) hardware embodiments, as well as custom VLSI circuitry in combination with a general purpose DSP circuit, may also be provided.

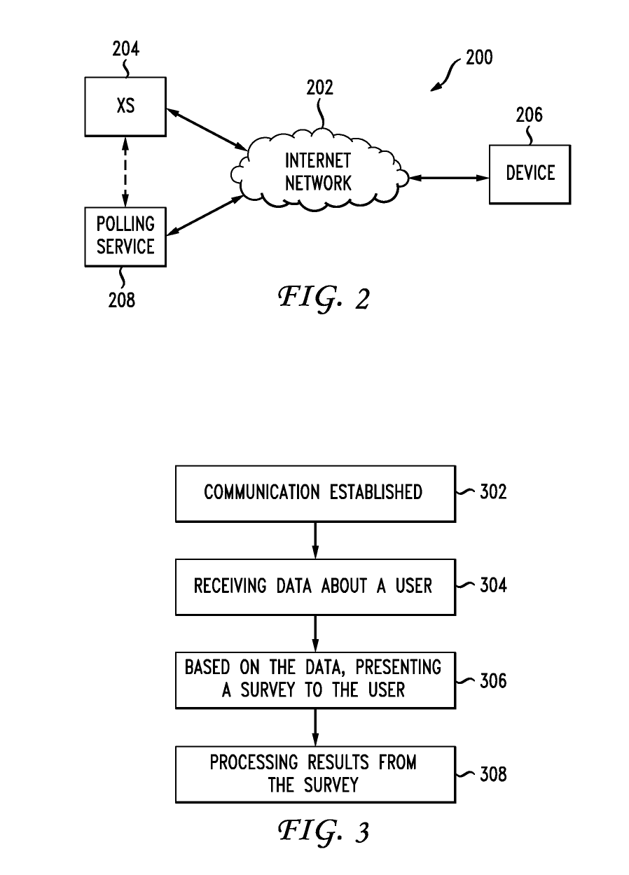

FIG. 2 illustrates a general system 200 in which the concepts of the present disclosure apply. The network 202 such as the internet, cellular network or any other type of network is used to communicate data between a device 206 and an audio source such as a radio station (RS) 204. An example of this general system is where the device 206 is a cell phone and a user can dial a phone number to communicate with the audio source 204 such as a radio station. Examples of the RS could be a server that communicates data over a network. The data can be audio only or audio and video or any combination of data. An additional feature that is associated with this disclosure is the use of a polling service 208 that communicates through the communication network 202 to the device 206 in such a way as to more efficiently and effectively provide a survey to the user of the device 206.

In one example, shown in FIG. 3, the system receives information that device 206 has established a communication (302) with an audio source 204. This is identified in step 302 in which a communication is established between a device and the audio or data source. At least some information about the user of the device, their location, interests, phone number, purchasing history and other patterns may be utilized along with the information about the audio source 204 can be received to aid in improving the survey process. The system receives such information about the user (304). The information can be used in any way in the survey process. A particular poll or survey may be selected and presented to the user based at least in part on the received data (306). For example, if a user uses device 206 to dial a phone number and listen to a radio program broadcast from a radio station 204, then the system can choose a sports-based survey and as the user begins to listen to the program, the system could obtain from the polling service 208 the sports related survey and present that to the user via the device 206 and thus have a higher probability of actually having the user decide to participate in the survey. The type of data utilized that is associated with the user can include one or more of political data, program data, historical data, sporting data, hobby data, work data, social networking data, family data, religious data, income data, and purchasing history. Other types of data of course could be used as well. Thus, the system could present a 4 question survey and enable the user to either provide responses via voice or a DTMF tone or via interaction with an application on the device 206, to engage in the survey and provide the feedback back to the polling service 208. In this manner, the system can utilize and take advantage of a particular mechanism by which a user communicates or is receiving audio in the particular system 200 and thus introduce a poll or a survey into that experience which has a higher likelihood of actually being taken than would otherwise be achieved via door-to-door or cold calling polling.

The system can process the poll data (308) in order to combine the data for multiple people taking the poll or the survey so that it may be presented in a useful way.

In addition to the ability to provide polling opportunities, the system, because the user is communicating via a device 206 with a radio station 204, could choose particular portions of the program in which to insert polls. For example, with a communication between the polling service 208 and the radio station 204, gaps in the programming could be identified in which commercials might normally be presented, if a three minute gap exists then the polling service could perhaps choose a three minute poll with which to present to the user during that gap 20 minutes into the program. In this respect, the system may not only utilize information data known about the user gathered from any source available, but could also choose a poll based on a period of time within a program that a particular poll could fit in and be presented to a user.

In one example, when a user calls, and doesn't listen to a particular audio stream, the user may be presented initially with a question which could say press 1 to listen to radio station XYZ or press 2 to take a survey on gun control. If the user presses 2, then the system would proceed to engage the user in the survey in which responses would be texted, chosen via DTMF tone, stated orally or some other mechanism. The system may randomize answers or may even be able to be structured such that users can provide natural language or voice input as opposed to multiple choice type answers.

Therefore, utilizing the type of information that you can obtain about a user based on which radio station they call, as well as other data such as the timing of the call, the particular program that is being played on the radio station when they call, and so forth, the system can process surveys and polls in such a way as to render them much more efficient and effective than would otherwise be available. For example, the system may know the language of the user, the political affiliation of the user, their interests in sports or politics, and so on based simply on a little bit of data that can easily be obtained in the context of a telephone call to a radio station. Thus, the ability to utilize the demographic information obtainable via the communication with the radio station enables a much more accurate gathering of data which could then be processed by polling algorithms to arrive at more accurate polling results. The novelties of this approach involve the fact that the polling is chosen and initiated for inbound communications to audio sources such as radio stations at which point the information is obtained about the caller and particular polls or other decisions can be made with regard to when and how to conduct a survey or a poll based on the received data. The communication between the device 206 and other entities can occur via a cellular connection, a data connection, a combination of both connections, or a combination of different communication modalities. The communication can be a wire line or a wireless communication. There is no essential limitation on how the communication occurs. In one embodiment, the device makes a phone call and thus dials a phone number to communicate ultimately with the audio source 204. However, such a communication could occur in other ways as well.

One example of a dual approach could be that a user on device 206 makes a phone call to listen to a streaming radio station and the audio that is heard as the program begins includes a request to the user of device 206 that they take a survey. If the user affirms via a communication that they do desire to take a survey, the system may instruct them to open up or look at the screen on their phone at which point a survey could be presented or they can choose an application which would then present a survey that is chosen and/or processed in some way based on the information obtained by virtue of the call. Then the user could quickly participate in a survey using an app on a touch screen rather than via a telephone call using DTMF tones. A combination of these modalities could also be provided in order to achieve the survey. Such an approach, however, highlights the combination of different communication modes in order to achieve a successful and relevant survey from an interested party.

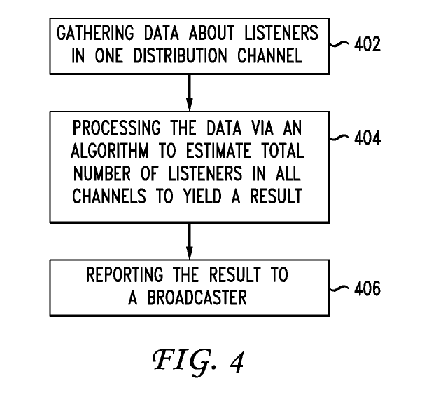

Another aspect of this disclosure relates to providing data to a broadcaster about the listening audience. FIG. 4 generally illustrates this approach. The broadcaster may have many outlets or channels for a signal such as over-the-air, over the internet, via a system where callers can call into a phone number and listen to the broadcast, etc. An exemplary system will measure for a radio station or a broadcaster, the number of listeners in a particular increment of time, such as every 15 minutes, or every 5 minutes. This time period can be a rolling window such as from the start of an advertisement or static such as increments from Noon to 12:15 PM. This system measures or gathers information about the actual number of listeners on a particular system or channel (such as over the internet, or those that call in, or a combination thereof) (402), which can then be processed by an algorithm to provide an up-to-date, dynamic and ‘live’ view for broadcasters of their listening audience.

In one example, the system can be triggered to provide a report on listeners right after a poll is taken by a host or a broadcaster system, or the 5 minutes after an advertisement is provided.

In this regard, the system will receive data indicating a start time and a timing increment associated with a report on a listening audience. The system will measure the number of listeners during that period of time and provide a report. The report or data will represent a portion of the total listening audience but can be processed with an algorithm that relates to processing in an unbiased way representative samples taken in a defined market area. The system processes the data via an algorithm that can estimate the number of total listeners from all the different channels (404). The result from processing via the algorithm is an estimate of the total listeners. From the representative sample, and based on the marketing, the system provides to a broadcaster an accurate estimate of the total number of listeners for a show or a portion of a show in a market (406).

The result provided can aid a broadcaster in programming and sales decisions and can be used to drive advertising costs. The raw data of listeners on the channel can be extrapolated through the algorithm to a representative sample based on promotional activity from the station. The sample size can be generalized to provide market data for the broadcaster. For example, the channel can be telephone calls to a system and the overall market of listeners can include those on a data plan using applications on smartphones and over-the-air listeners.

This data, provided on a particular increment of time, can inform broadcasters about which shows are most popular and least popular. It can do this on a real-time or almost real-time basis as actual listeners are using a particular platform. Thus, the system can monitor one platform (such as calls into the system that connects the calls to the broadcaster stream) and provide live information of the estimate of the total number of listeners in a market. This approach provides a benefit to broadcasters because they can get real-time measurements of the popularity of their content. Otherwise, they have to wait 30 days for a detailed report from existing entities.

In one aspect, the system will also utilize, if available, data from another distribution stream in order to supplements the algorithm. Thus, if the system is measuring calls into a first system for connecting end users with the broadcaster, the system me receive additional data such as the number of web streams connecting web users to the broadcaster. That data can be used to enhance the accuracy of the algorithm that is processing the data on callers in order to estimate the total number of listeners.

The data processed will also illustrate not just actual market wide listening but also the popularity of one show relative to another show from the same broadcaster. The system can receive the appropriate data from its measurements, process the data with or without data from other distribution channels, and present to a broadcaster a report that represents an estimate of the total number of listeners, and in one aspect, the report covers particular time increments such as every 15 minutes on the hour, or other increments starting at any chosen time. In one aspect, the data can be generalized with information given to the broadcaster about timing elements such as advertisements and polls taken, such that the broadcaster can highlight or choose their own increment of time. For example, the broadcaster may have provided a poll to its users at 1:12 PM, ‘press 1 is you like pizza more than hamburgers.’ Then, the broadcaster may want to see the data for the next 10 minutes, from 1:12 to 1:22 PM. The broadcaster may also just promote a phone number periodically during an hour where sampling is done to populate and promote the access channel to the content. Thus, the present system can enable broadcasters to choose the time increments and even choose several to compare the estimated total number of listeners on an ongoing basis or based on one time increment relative to another.

Embodiments within the scope of the present invention may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the invention may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

Although the above description may contain specific details, they should not be construed as limiting the claims in any way. Other configurations of the described embodiments of the invention are part of the scope of this invention. Accordingly, the appended claims and their legal equivalents should only define the invention, rather than any specific examples given.

I claim:

1. A method comprising:
establishing a communication between a device associated with a user and a server;
receiving data about the user;
based on the data, presenting a survey to the user during the communication between the device and the server to yield survey data; and
processing the survey data.

2. The method of claim 1, wherein presenting the survey occurs in a break in a program streamed from the server to the device during the communication.

3. The method of claim 1, where the data about the user comprises data associated with a data program associated with the communication established between the device and the server.

4. The method of claim 1, wherein the data about the user comprises one of political data, program data, historical data, sporting data, hobby data, work data, social networking data, family data, religious data, income data, and purchasing history.

5. The method of claim 1, wherein processing the survey data comprises processing the survey data for multiple people taking the survey.

6. The method of claim 1, further comprising choosing the survey based on the data and a match between a time the survey will take and an opening of time of the communication.

7. The method of claim 6, wherein the opening of time is an advertisement period of time in the communication.

8. A system comprising:
a processor; and
a computer-readable storage medium storing instructions which, when executed by the processor, cause the processor to perform operations comprising:
establishing a communication between a device associated with a user and a server;
receiving data about the user;
based on the data, presenting a survey to the user during the communication between the device and the server to yield survey data; and
processing the survey data.

9. A computer-readable storage memory device storing instructions which, when executed by a processor, cause the processor to perform operations comprising:
establishing a communication between a device associated with a user and a server;
receiving data about the user;
based on the data, presenting a survey to the user during the communication between the device and the server to yield survey data; and
processing the survey data.
